(19) United States
(12) Patent Application Publication
(10) Pub. No.: US 2006/0259723 A1
(43) Pub. Date: Nov. 16, 2006

(54) System and method for backing up data

(76) Inventor: Stephen E. Petruzzo, Great Falls, VA (US)

Correspondence Address: CAHN & SAMUELS LLP, 2000 P STREET NW, SUITE 200, WASHINGTON, DC, 20036, US

(21) Appl. No.: 11/274,886

(22) Filed: Nov. 16, 2005

Related U.S. Application Data
(60) Provisional application No. 60/627,971, filed on Nov. 16, 2004.

(51) Int. Cl. G06F 12/00

(52) U.S. Cl. 711/162

(57) ABSTRACT

In at least one exemplary embodiment, the system includes a primary data storage space including a first non-volatile buffer and a secondary data storage space including a second non-volatile buffer. Mirroring is performed to cause data stored on the secondary data storage space to replicate data stored on the primary data storage space and input/output requests affecting the primary data storage space are logged to at least the first non-volatile buffer to provide fail-over response if an event affecting data on the primary data storage space or data on the secondary data storage space. In at least one exemplary embodiment, data input/output operations are executed while the secondary storage space is undergoing a mirror operation, thereby resulting in possible reduced latency.

This patent application claims the benefit of U.S. Provisional Patent Application No. 60/627,971, filed Nov. 16, 2004, which is hereby incorporated by reference.

### I. FIELD OF THE INVENTION

The present invention relates generally to safeguarding data, and more particularly to a system and method for mirroring data.

### II. BACKGROUND OF THE INVENTION

It is almost axiomatic that a good computer data network should be able to still function if a catastrophic event such as the “crash” of a disk should occur. Thus, network administrators typically perform routine processes in which data is backed up to prevent its permanent loss if such an event were to occur. When such an event occurs, the backup version of the data can be introduced into the computer network and operation of the network can continue as normal. Although routine backup processes are typically effective in restoring data on the network to allow normal operation to continue, they often do not safeguard against the loss of all data. For instance, data that is introduced into the computer network at a time period shortly after a routine backup operation is completed is often permanently loss if a catastrophic event occurs before a subsequent backup operation.

In an effort to prevent such a type of loss, in addition to performing back up processes, network administrators often use a process known as mirroring. Such a process typically includes copying data from a first data storage location to at least one other data storage location in real time. If a catastrophic event such as a “disk crash” occurs, a failover operation can then be implemented to switch to a standby database or disk storage space, thereby preventing or acutely minimizing data loss. As the data is copied in real time, the data on the other data storage location is a substantial replica of the data residing on the first data storage location most of the time. Mirroring is often strongest when it is performed remotely. Although remote mirroring is ideal, it is sometimes not used because of its degradation on input/output performance of the network. For instance, transmission latency, for example, the time it takes to copy from the main storage device to the mirror, is often one of the greatest deterrents to remote data mirroring.

Data mirroring has a significant problem similar to that described above with respect to performing routine data backups. Data as part of an I/O request introduced into the network prior to the mirroring processes is subject to permanent loss if the main storage device becomes inoperable, for example, crashes, while processing the I/O request that has not been sent to the mirror storage device. Such a result can be disastrous for a critical computer data network such as one utilized by an intelligence agency, a financial institution or network, a computer data medical network, or any other computer data network in which it is essential to prevent any loss of data.

In light of the foregoing, what is needed is a system and method for mirroring data, reducing data transmission latency, and preparing for data failover and/or synchronization.

### III. SUMMARY OF THE INVENTION

In at least one exemplary embodiment, a system according to the invention includes a primary data storage space having a first non-volatile buffer and a secondary data storage space having a second non-volatile buffer in at least one exemplary embodiment wherein mirroring is performed to cause data stored on the secondary data storage space to replicate data stored on the primary data storage space and input/output requests affecting the primary data storage space are logged on at least the first non-volatile buffer to manage an event affecting data on the primary data storage space or data on the secondary data storage space.

In at least one exemplary embodiment, a method of the present invention includes logging a current data operation in a non-volatile buffer on a first device, executing the current data operation on the first device, transmitting the current data operation to a second device as the current data operation occurs on the first device, receiving a confirmation from the second device that the current data operation has been executed, and executing a subsequent data operation on the first device. The system and method of the invention can reduce latency and better prepare a network storage device for failover procedures.

In at least one exemplary embodiment, a method for mirroring data and preparing for failover, including logging a first data operation in a non-volatile buffer on a first device; executing the first data operation on the first device; transmitting the first data operation to a second device from the buffer on the first device; executing the first data operation on the second device; receiving a confirmation from the second device that the first data operation has been executed; logging a second data operation in the buffer on the first device; and executing a subsequent data operation on the first device.

In at least one exemplary embodiment, a system for providing fail-over for data storage includes a primary data storage unit including a buffer; a secondary data storage unit including a buffer; means for communicating between the primary data storage unit and the secondary data storage unit; and each buffer includes means for receiving a data operation and means for forwarding the data operation to at least one data storage unit.

In at least one exemplary embodiment, a system for providing failover protection for each data operation communication to the system, the system includes a first storage device having a non-volatile buffer; a second storage device; means for logging at least one data operation in the non-volatile buffer on the first storage device; means for executing the data operation on the first storage device; means for transmitting the data operation to the second storage device from the non-volatile buffer on the first storage device; means for executing the transmitted data operation on the second storage device; means for receiving a confirmation from the second storage device that the transmitted data operation has been executed.

### IV. BRIEF DESCRIPTION OF THE DRAWINGS

Like reference numerals in the figures represent and refer to the same element or function throughout.

FIG. 1 illustrates an exemplary mirroring system according to at least one embodiment of the present invention.

FIG. 2 is a flow diagram illustrating an exemplary method of mirroring employed by the system of FIG. 1 according to at least one embodiment of the present invention.

FIG. 3 is a flow diagram illustrating an exemplary method of processing input/output requests according to at least one embodiment of the present invention.

FIG. 4 illustrates an exemplary configuration according to at least one embodiment of the present invention.

FIG. 5 depicts an exemplary configuration according to at least one embodiment of the present invention.

FIG. 6A illustrate an exemplary backup system according to at least one embodiment of the present invention.

FIG. 6B depicts a flow diagram illustrating an exemplary method for performing a backup operation for the backup system of FIG. 6A according to at least one embodiment of the present invention.

### V. DETAILED DESCRIPTION OF THE DRAWINGS

The present invention relates to a system and method for mirroring data and preparing for data failover. The system also logs data input/output requests to prepare for failover and improve the integrity of the mirroring process. When one storage unit has a failure and becomes unusable, by switching the IP address or the DNS entry, the mirror storage unit can take the place of the primary storage unit (or a replacement storage unit or back-up storage unit can take the place of the mirror storage unit).

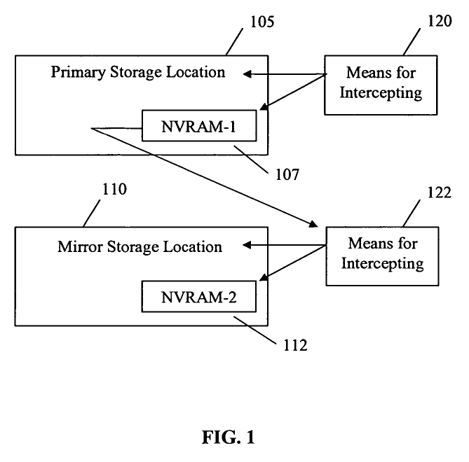

FIG. 1 illustrates an exemplary embodiment having a mirroring system 100 that includes a primary storage unit 105 and a mirror storage unit 110. For example, in at least one exemplary embodiment, each of the storage units include multiple hard drives in a RAID arrangement, for example, 12 160 GB hard drives are arranged to provide 1 terabyte of storage while using the highest performance portion of each hard drive in the array to improve access times. The arrangement, the number, and the size of the hard drives used for a storage unit can vary depending upon the storage requirements of the system. In addition, there may be multiple storage units pooled together to form larger storage units. Additionally, the entire hard drive may be used instead of the highest performance portion.

Each of the storage units preferably includes a buffer storage space. For example, the illustrated primary storage unit (or first device) 105 includes a non-volatile random access memory (NVRAM) or other buffer storage 107. Likewise, the illustrated mirror storage unit (or second device) 110 includes a NVRAM 112, which may be omitted but if omitted then the mirror storage unit will not be able to fully replace the primary storage unit. The NVRAM 107 and the NVRAM 112 in the discussed exemplary embodiments preferably have the same capabilities unless noted otherwise. In at least one embodiment, the NVRAM is included on a memory card such as an eight gigabyte PC3200 DDR REG ECC (8×1 gigabyte) random access memory card. In at least one embodiment, the system 100 includes an emergency reboot capability. In such an embodiment, the NVRAM resides on a card with its own processor so that if the primary storage unit 105 crashes and is unable to recover, the NVRAM is able to transmit the last few instructions relating to, for example, writing, deleting, copying, or moving data within the storage unit to the mirror storage unit 110. In at least one embodiment in which the system 100 includes an emergency reboot capability, the card includes a power source to supply power to the card to complete the transmission of the last few instructions. Either of the last two embodiments can be thought of as an emergency reboot capability.

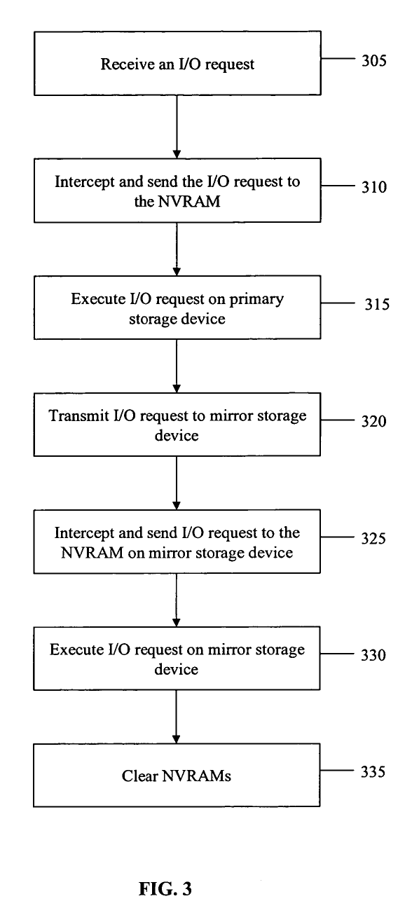

For purposes of explanation, primary means for intercepting 120 and mirror means for intercepting 122 are also illustrated in FIG. 1. For example, in at least one embodiment, primary intercepting means 120 and mirror intercepting means 122 are each software, for example, computer program modules, resident in their respective units for intercepting I/O request(s) and logging the I/O request(s) in the NVRAM before (or simultaneously with) the I/O request(s) are executed by the storage unit. The flow of instructions between the primary storage unit 105 and the mirror storage unit 110 including their respective buffer storage spaces will be explained in more detail with respect to FIG. 3.

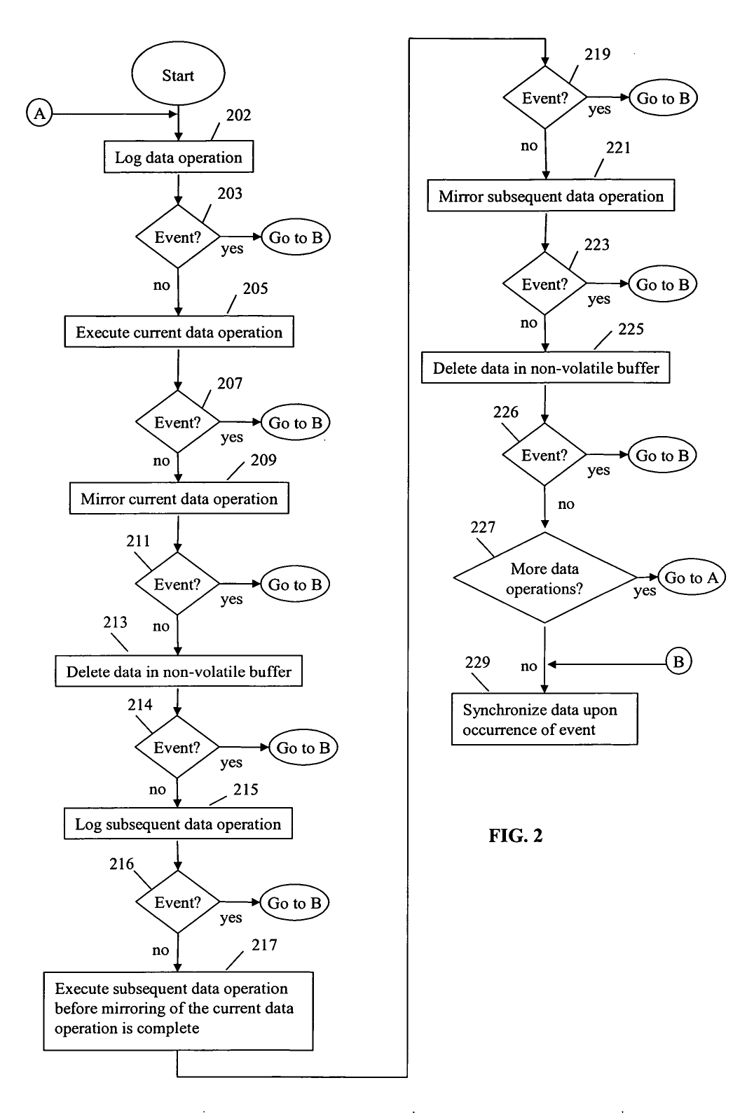

Referring now to FIGS. 1 and 2, in step 202 of FIG. 2, at least one data operation such as a data input/output request is logged in the NVRAM-1 107. In decision step 203, if it is determined whether an event has occurred, and if an event has occurred then step 229 is executed. Examples of an event that would cause synchronization in this exemplary embodiment include, for example, the buffer 107 filling up (or reaching a predetermined limit), the primary storage unit 105 crashing or having other hardwire issues, and the communication link with the mirror storage unit 110 is restored after a communication failure. In at least one embodiment, synchronization automatically occurs after a request for file synchronization and/or a request from a database to commit a transaction. In step 229, all data is synchronized between the two storage units. In other words, the primary storage unit 105 is synchronized with the mirror storage unit 110, as would be known to those of ordinary skill in the relevant art after being presented with the disclosure herein. In the illustrated embodiment, synchronization occurs during specified events as opposed to frequent predetermined time intervals; however, synchronization could occur at predetermined time intervals.

In step 205, the data operation is executed. In at least one exemplary embodiment, only data operations that change stored data are sent to the mirror storage unit 110. For example, a data write operation may be executed to write a new block of data to the primary storage unit 105 and this type of operation will also occur on the mirror storage unit 110. As illustrated in FIG. 2, after each step, it is determined whether an event has occurred that requires the storage units to be synchronized. For example, in at least one embodiment, the storage units are randomly synchronized. It should be noted that the storage units are also preferably synchronized upon bringing one of the storage units on-line, for example, after a mirror storage unit is brought on-line. In at least one embodiment, the determination as to whether the above-referenced event has occurred is determined by whether the communication link of one or both of the storage units has been interrupted (or disrupted).

In decision step 207, if it is determined that an event has occurred, and then step 229 is executed.

In step 209, the data operation that was executed in step 205 is executed on the mirror storage unit, for example, mirror storage unit 110. After a determination is made as to whether an event has occurred in step 211, in step 213, data relating to the data operation is erased from the non-volatile buffers in both the primary and mirror storage units, for example, by having the mirror storage unit 110 notify the primary storage unit 105 of completion of the data operation. Steps 205 and 209 may be performed in reverse order to that illustrated in FIG. 2 or simultaneously. Step 213 may occur prior to step 205 or simultaneously with step 205. In step 214, it is determined whether an event has occurred.

In step 215, a subsequent data operation is logged in the non-volatile buffer to prepare for a fail over. In decision step 216, it is determined whether an event has occurred.

In step 217, in at least one embodiment, a subsequent data operation is executed before mirroring of the data operation executed in step 209 has completed. Executing the subsequent data operation before the previous data operation has been completed on the mirror storage unit 110 can reduce latency during the mirroring process, as data operations on the primary storage unit 105 can continue without being delayed due to waiting on the data operation on the mirror storage unit 110 to complete. Since the data operation is stored in a buffer 107, the data operation will be available for transmission to the mirror storage unit 110. In at least one embodiment, the subsequent data operation is not executed on the primary storage unit 105 until after the mirroring of the current data operation has occurred. In such a situation, after the current data operation has been completed on the primary storage unit 105, completion is not signaled to the process requesting the I/O on the primary storage unit 105 until after the current data operation has been completed on the mirror storage unit 110.

In step 221, the subsequent data operation is mirrored. In step 225, data relating to the data operation is removed, for example, erased, from non-volatile buffers in both the primary storage unit 105 and the mirror storage unit 110 upon performance of the data operation by the mirror storage unit 110. In step 226, a determination is made regarding whether an event has occurred. If it is determined in step 227 that there are more data operations, steps 202-226 are repeated. Alternatively, if it is determined that there are no more data operations to be processed, in step 229, in at least one embodiment, the data is synchronize upon occurrence of an event such as one of the events described above. Alternatively, the system waits for the next data operation. Another embodiment eliminates one or more of event decision steps from the method.

Referring now to FIG. 3, in step 305, an I/O request is received as the data operation at the primary storage unit 105. For example, in at least one embodiment, a data write operation is received that includes data to be written and a particular block address where the data is to be written within the primary storage unit 105.

In step 310, the I/O request received in step 305 is intercepted and transmitted to (or logged in) the NVRAM-1 107, in preparation for a fail-over situation. In particular, if the primary storage unit 105 should experience a disk crash before the I/O request can be processed, when the repaired primary storage unit 105 or its replacement storage unit (such as the mirror storage unit 110) enters an on-line state, the I/O request can be transmitted from the NVRAM-1 107 and executed, thereby minimizing restoration time.

In at least one exemplary embodiment, at least one data block pointer to the data block associated with an instruction, for example, is written to the NVRAM-1 107. For example, continuing with the write operation offered above, in step 310, a pointer to the actual data block that is to be written to the primary storage unit 105 is sent to the NVRAM-1 107. If a mishap such as crash of the mirror storage unit 110 were to occur before the data is actually written to the mirror storage unit 110, the copy of the data in the NVRAM-1 107 can be accessed and written to the mirror storage unit replacement. In at least one embodiment, the actual data to be written is stored in the NVRAM-1 107.

In addition to handling a failover situation in which the mirror storage unit 110 crashes, the present invention also provides an embodiment that handles a failover situation in which the primary storage unit 105 crashes. In particular, in at least one embodiment, data associated with an instruction is stored in the NVRAM-1 107. For example, continuing with the example offered above, in step 310, the actual data block that is to be written to the primary storage unit 105 is written to the NVRAM-1 107. In such a situation, if the primary storage unit 105 were to experience a disk crash, thereby rendering its data inaccessible, the data can be copied from the NVRAM-1 107 to the primary storage unit replacement and ultimately to the mirror storage unit 110, which likely would be the primary storage unit replacement. In particular, in at least one embodiment, a central processing unit (CPU) on the primary storage unit 105 reboots with an emergency operating system kernel which is responsible for accessing the NVRAM-1 107 and performs data synchronization with mirror storage unit 110. The NVRAM logged data and the block pointers, for example, stored therein can be used to replay the mirror block updates and then the input/output requests that were “in flight” when the primary storage unit failed. The mirror storage unit 110 or another storage unit can then transparently take over input/output requests. In at least one embodiment, the processing card on which the NVRAM-1 107 is stored includes its own Central Processing Unit (CPU) which can perform a synchronization regardless of whether the primary storage unit 105 is operable.

In step 315, the I/O request is executed on the primary storage unit 105. For example, the data is written to a block address within the primary storage unit 105.

It should be noted that the order of steps in FIG. 3 represents a sequence of steps performed in an exemplary embodiment. The order of steps may vary. For example, in at least one exemplary embodiment, step 315 occurs before step 310. Alternatively, in at least one exemplary embodiment, the steps 310 and 315 occur simultaneously.

In step 320, the instruction received in the NVRAM-1 107 (shown in FIG. 1) is preferably transmitted from the NVRAM-1 107 to the mirror storage unit 110 and/or the means for intercepting 122. In at least one embodiment, the instruction is transmitted from the NVRAM-1 107 to the NVRAM-2 112. It should be noted that step 320 may not occur at the exact sequence point as illustrated in FIG. 3. For example, in at least one embodiment, step 320 may occur at the same time as or before step 310 and/or step 315.

In step 325, the I/O request is transmitted from the intercepting means 122 to the NVRAM-2 112 in preparation for failover. In-particular, if the primary storage unit 105 should experience a disk crash, for example, the mirror storage unit 110 can serve as the primary storage unit. In at least one embodiment, a synchronization is performed before the primary storage unit 105 experiences a disk crash to bring the mirror storage unit 110 up-to-date compared to the primary storage unit 105. When the primary storage unit 105 experiences a disk crash, a function of the mirror storage unit 110 will require replacement by a new mirror storage unit, which is preferably added to the system to serve the function of the mirror storage unit 110. Logging to the NVRAMs preferably continues after the replacement with the mirror storage unit 110 serving as the primary storage unit. When the original mirror storage unit 110 receives an I/O request, the I/O request will be transmitted to an NVRAM on the original mirror storage unit 110 and then ultimately transmitted to an NVRAM on the new mirror storage unit. In at least one embodiment, the primary storage unit 105 is rebuilt from the mirror storage unit 110. After the primary storage unit 105 is rebuilt, input/output operations on the primary storage unit 105 are performed.

It should be noted that the primary storage unit 105 may crash before a synchronization is possible. In such an instance, the primary storage unit 105 preferably reboots with an emergency kernel whose job includes accessing the NVRAM-1 107 and performing a synchronization and/or transmission of any pending data operations. In at least one embodiment, as mentioned in the text accompanying FIG. 1, the NVRAM-1 107 includes its own processor which performs synchronization and/or transmission of any pending data operations even when the primary storage unit 105 is inoperable, for example, when a disk crash is experienced.

Failover preparation also occurs when the mirror storage unit 110 or the network to the mirror storage unit 110 should experience a disk crash, mirror block pointers preferably remain in the NVRAM-1 107, for example, as the asynchronous mirror input/output has not been completed. When the mirror storage unit 110 is again available, data blocks from the primary storage unit 105 identified by the NVRAM pointer(s) are preferably asynchronously copied over to the mirror storage unit 110.

In step 330, the I/O request is executed on the mirror storage unit 110.

In step 335, the NVRAM-1 107 is preferably cleared. For example, in step 335, after all data operations are allowed to complete, the data logged in NVRAM-1 107 is preferably flushed or cleared. An exemplary method of accomplishing this is for the mirror storage unit 110 to send a signal to the NVRAM-1 107 confirming the I/O request has been performed. It should be noted, however, that the NVRAM-1 107 may also be cleared at other times. In particular, in at least one embodiment, synchronization automatically occurs when the NVRAM-1 107 is full. In at least one exemplary embodiment, synchronization automatically occurs with a secondary mirror storage unit of the mirror storage unit when the NVRAM-2 112 is full. In an embodiment where there is not a secondary mirror storage unit to the mirror storage unit 110, then the completed data operation is cleared form the NVRAM-2 112.

It should be noted that the present invention can be utilized in conjunction with other utilities. For instance, Linux, such as Suse Linux, Knoppix Linux, Red Hat Linux, or Debian Linux high availability clustering, mirroring and fail-over capabilities can be utilized by the present invention in conjunction with the NVRAM data logging feature and the emergency reboot capability mentioned above. Such mirroring and fail-over facilities can work with networking input/output protocols used by storage devices, for example, Unix/Linux clients, SMB for Microsoft® Windows clients, and Internet Small Computer Systems Interface (ISCSI).

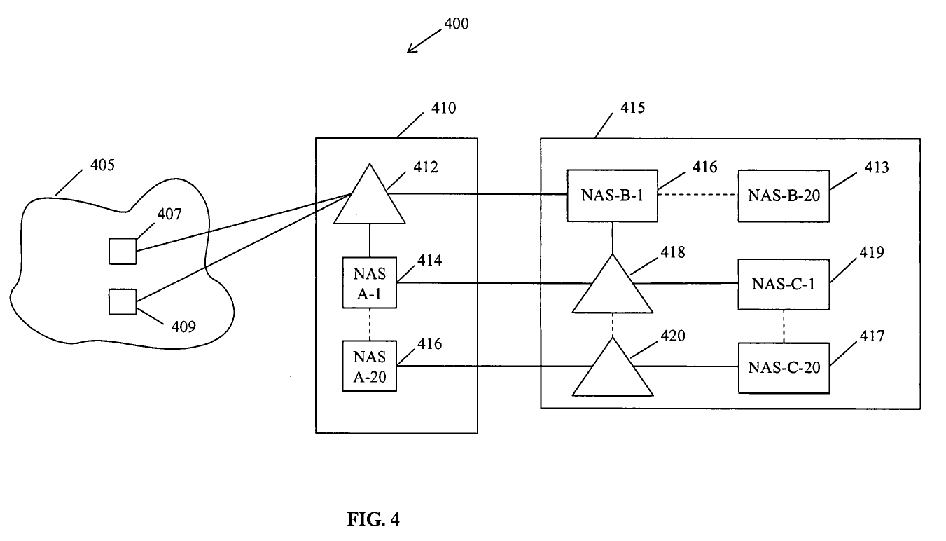

FIG. 4 illustrates a system 400 that includes a distributed twenty terabyte Network Attached Storage (NAS) configuration in which the at least one exemplary embodiment can be utilized. After being presented with the disclosure herein, one of ordinary skill in the relevant art will appreciate that although twenty storage units (or devices) are illustrated in FIG. 4, any viable number of storage device sets can be used, for example, one or more of the storage devices. Network File System (NFS) can provide UNIX client file connectivity, and SAMBA can provide Microsoft Windows client connectivity. The XFS file system can provide a solid, scalable journaling file system. The Logical Volume Manager (LVM) can be utilized to administer the large volumes of data and provide “snapshot” capability which can allow backups to be conducted without stopping primary input/output operations. The Enhanced Network Block Device (ENBD) can allow remote mirroring to be accomplished, as it can cause a remote file-system to appear as a local disk so the remote file system can be specified as a mirror in a standard Linux RAID 1 setup. ENBD can also perform other functions which can cause remote mirroring to be practical. For example, RAID 1 can automatically be rebuilt in an entire mirror when a “bad disk” has to be replaced. ENBD is “intelligent” enough to know that after a bad disk condition is created by network service interruption, the mirror can be incrementally rebuilt with just those disk blocks changed during the network interruption.

Domain Name Service (DNS), the standard Internet Protocol (IP) dynamic name service, can enable UNIX and Windows clients to locate remote NAS file resources. Using DNS round robin IP assignment, I/O work load balancing can be achieved between the primary and mirror NAS machines, in such a case, both NAS machines should serve as primaries and would serve as mirrors for the other NAS machine, i.e., when one machine receives a data operation manipulating data it will transmit the data operation to the second machine. It should be noted that a code change to the root DNS server can be performed so that it only assigns an IP address if a particular machine is operable.

In the example shown in FIG. 4, a distributed 20 terabyte configuration is shown that includes Unix and Microsoft Windows client machines in the “outside world” 405. A large gigabit switch 412 in addition to approximately twenty NAS-A primary machines, for example, NAS-A-1 414 through NAS-A-20 416, are located in a rack in a first building 410, as illustrated in FIG. 4. As illustrated in FIG. 4, a second building 415 includes twenty NAS-B mirror machines, for example, NAS-B-1 416 through NAS-B-20 413, twenty NAS-C backup machines, for example, NAS-C-1 419 through NAS-C-20 417, and twenty smaller switches, for example, switch 418 through switch 420 located in, for example, racks in the second building 415. It should be noted that the configuration depicted in FIG. 4 requires a bundle of approximately eighty cables (or equivalent bandwidth) connecting the first building 410 to the second building 415. But this is very reasonable since it enables the real-time mirroring of a twenty terabyte setup, and a full twenty terabyte backup of the entire configuration in less than one hour.

The primary machine NAS-A-1 414 in FIG. 4 and the mirror machine NAS-B-1 416, are preferably both configured with four one gigabit Network Information Cards (NICs), two of which preferably plug into a gigabit switch 412, which preferably connects the machines to the “outside world”, for example, at least one group 407 of Microsoft Windows clients and at least one group 409 of Unix clients although different client types could be present instead. The other two NICs of each machine are preferably plugged into a small, 8-port gigabit switch 418, which is connected to the backup machine NAS-C-1 419. Each NAS-C machine preferably includes 4 NICS, and each of the 4 NICS preferably plugs into a small gigabit switch. For example, NAS-C-20 417 preferably includes 4 NICS that plug into the small, 8-port gigabit switch 420, as shown in FIG. 4. In at least one embodiment, each NAS machine preferably includes twelve 120 gigabyte SATA hard drives attached together using a hardware RAID, for example set up as a RAID 5 configuration.

Good throughput is experienced by the system, as both NAS-A and NAS-B machines are used as DNS load balanced primaries in the illustrated embodiment. Thus, approximately half the workload was being accomplished by each machine. This is preferably ideal as read activity is usually higher than update activity requiring mirroring. In situations of high update activity, it is probably best to configure the NAS-B machines as dedicated to mirroring and fail-over.

When it is required to recover a file from a NAS-C backup, the required NAS-C file system was mounted, and “DD copy” was used to copy the required file. In cases where client machines (that is, in cases which other machines in addition to the NASs) required connectivity to NAS backup machines, corresponding NAS-A and NAS-B machines provided needed IP forwarding, as NAS-C machines did not have a direct connection to the big gigabyte switch 412 shown in FIG. 4.

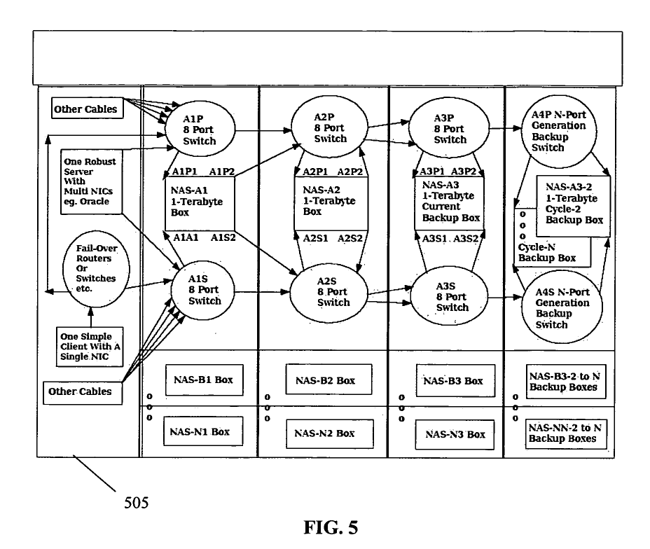

FIG. 5 illustrates an exemplary implementation of the invention. The client and server side of the network being located in the outside world 505 and connected to the data storage through a plurality of switches, which in the illustrated embodiment are 8 port switches, that have two levels of redundancy between A1P, A2P, A3P, A4P to the ANP switches and A1S, A2S, A3S, A4S to the ANS switches for each level of terabyte NAS units. Each illustrated set of terabyte NAS units includes a primary data unit NAS-A1, a mirror data unit NAS-A2, a current backup data unit NAS-A3, and at least one prior generation backup data unit NAS-A3-2 through NAS-A3-N. As illustrated in FIG. 5, the system may be expanded for multiple terabyte storage from NAS-B to NAS-N each with there respective set of switches (not illustrated). In an ideal environment, the primary data units would be located in one building, the mirror data units would be located in a second building, the current backup data units would be located in a third building, and each additional set of backup data units would be located in their own building. A compromise arrangement would have the primary data units in building one and the remaining units located in building two similar to the arrangement illustrated in FIG. 4. However, a variety of combinations would be possible including having all the data units in one building.

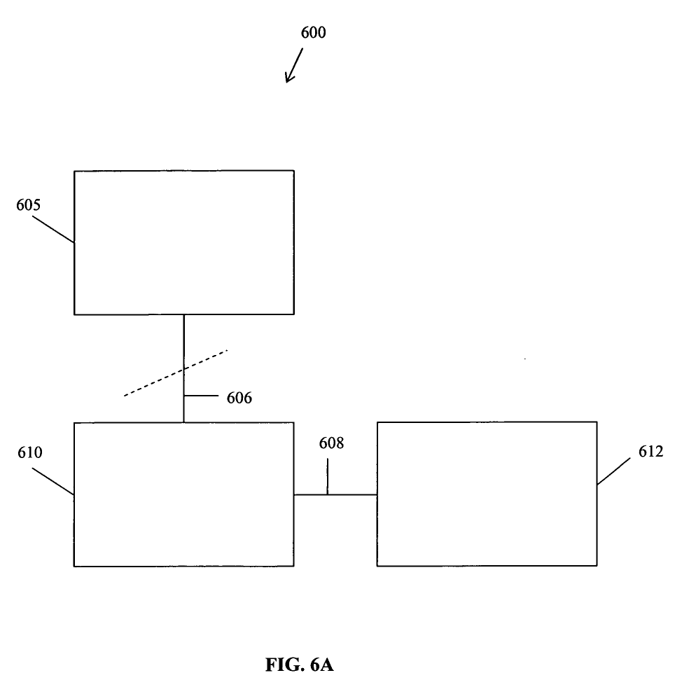

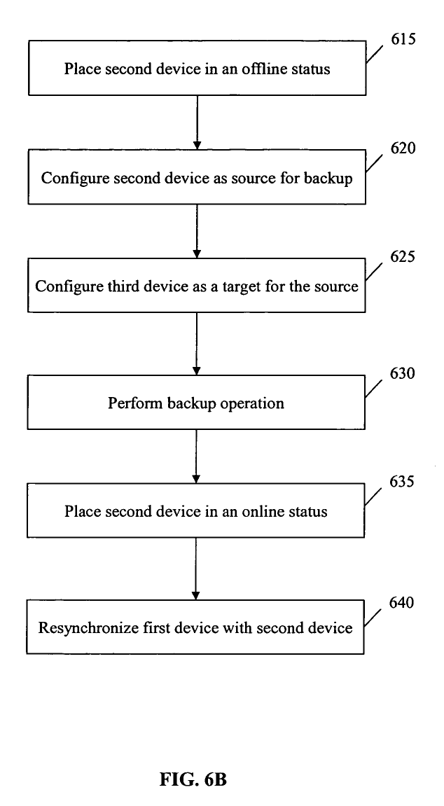

Backups for the systems illustrated in FIGS. 4 and 5 were executed smoothly, without interruption. The back-up methodology illustrated in FIG. 6B allows the primary storage unit to continue to operate with no performance depreciation (or little impact on performance) during a back-up routine when the back-up is taken from the mirror storage unit. Alternatively, when load balancing is used between a primary storage unit and a mirror storage unit the methodology will still work. The performance impact is minimal on both units because the data present on the storage units is copied as it resides irrespective of the file system used to store the data. Using the exemplary system 400, for example, a back-up of a terabyte of data can occur in one hour or less due to the throughput that exists in the exemplary system 400 as described above in connection with FIG. 4. The data is copied irrespective of the file system used to store the data. Additionally, since each terabyte of data operates as a self-contained backup, additional terabytes of data are backed up in parallel thereby enabling many multi-terabyte configurations to be backed up in a total time of under one hour.

The testing of the system 400 illustrated in FIG. 4 included quiescing databases (for example, Oracle and DB2), quiescing the XFS file systems, taking logical LVM file system snapshots, and resuming the XFS file systems and databases. After this procedure, the NAS-A primary machines and NAS-B mirror machine snapshots were “DD copied” to the NAS-C machines, with the first six disk snapshots being transmitted from the NAS-A primary machines, and the second six disk snapshots coming from the NAS-B mirror machines. Finally, the snapshots were “LVM deleted.” The above described backup procedure was accomplished in approximately one hour, with no interruption of ongoing work, with the exception of a pause to quiesce and snapshot.

FIGS. 6A and 6B illustrate how offline backing up of data may occur. In step 615 of FIG. 6B, the connection 606 between the primary storage device 605 and the mirror storage device 610 is broken. For instance, the connection 606 may be broken (or disconnected from the primary storage device 605) by changing an Internet Protocol (IP) address of the mirror storage device 610. It should be noted that database activity on the system 600 is preferably first quiesced to provide a backup point in time. In step 620, the mirror storage device 610 is preferably configured as a source for a backup operation to be performed. In other words, a copy of the data on the mirror storage device 610 will be transferred to a third storage device 612. In step 625, the third storage device 612 is preferably configured as a target for the backup operation to be performed. In step 630, the backup operation is preferably performed. In step 635, the mirror storage device 610 is preferably placed in an on-line status such that the connection 606 with the primary storage device 605 is restored. In step 640, the primary storage device 605 and the mirror storage device 610 are preferably resynchronized for data operations occurring since the mirror storage device 610 went offline. After the resynchronization, database activity on the system 600 preferably resumes.

While the mirror storage device 610 is offline, the primary storage device 605 preferably continues to handle production operations and changed block numbers are preferably logged in non-volatile buffers, for example, NVRAMs so that the mirror storage device 610 can be updated, that is, synchronized when it is brought back on-line after the backup has been completed.

The illustrated functional relationship during the backup is the mirror storage device 610 operates as a primary storage device 605, and the third storage device 612 operates as a mirror storage device through connection 608 as illustrated in FIG. 6A. Then mirroring software can be used to perform a complete, efficient re-synchronization of the mirror storage device 610 (which is now serving as a primary storage device) to the third storage device 612 (which is now serving as the mirror storage device). After the backup has been accomplished, the mirror storage device 610 is disconnected from the mirror backup 612 and is reconnected to the primary storage device 605, and the system automatically updates the mirror storage device 610 to match the primary storage device 605, which continued production operations while backups were performed, by transmitting the instructions stored in the buffer of the primary storage device 605 to the mirror storage device 610.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

These computer program instructions may also be stored in a computer-readable memory that can direct a computer or other programmable data processing apparatus to function in a particular manner, such that the instructions stored in the computer-readable memory produce an article of manufacture including instruction means or program code that implements the function specified in the flowchart block or blocks.

The computer program instructions may also be loaded, e.g., transmitted via a carrier wave, to a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Various templates and the database(s) according to the present invention may be stored locally on a provider's stand-alone computer terminal (or computing device), such as a desktop computer, laptop computer, palmtop computer, or personal digital assistant (PDA) or the like. Accordingly, the present invention may be carried out via a single computer system, such as a desktop computer or laptop computer.

As is known to those of ordinary skill in the art, network environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or an Extranet, as well unless otherwise noted. The term “computer network” shall incorporate publicly accessible computer networks and private computer networks.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

1-20. (canceled)

21. A method for backing up data contained in a storage system having a primary storage unit and a mirror storage unit to a backup storage unit, said method comprising:
disconnecting the mirror storage unit from the primary storage unit,
configuring the mirror storage unit as a source of information to be backed up,
configuring the backup storage unit as a destination of information to be backed up,
copying information from the mirror storage unit to the backup storage unit, and
reconnecting the mirror storage unit to the primary storage unit.

22. The method according to claim 21, wherein information copied from the mirror storage unit is information representative of changes to data stored on the mirror storage unit.

23. The method according to claim 21, wherein copying information includes taking at least one snapshot of at least a portion of the contents of the mirror storage unit and placing the at least one snapshot on the backup storage unit.

24. The method according to claim 21, wherein copying information includes synchronizing information contained on the mirror storage unit with information contained on said backup storage unit.

25. The method according to claim 21, said method further comprising resynchronizing the primary storage unit to the mirror storage unit after reconnection of the mirror storage unit to the primary storage unit.

26. The method according to claim 21, further comprising:
while the mirror storage unit is disconnected from the primary storage unit,
continuing to handle production operations with the primary storage unit, and
queuing production operations that perform modification of information present on the primary storage unit.

27. The method according to claim 26, wherein when the mirror storage unit reconnects to the primary storage unit, replicating queued production operations form the primary storage unit to the mirror storage unit.

28. A data backup system comprising:
a primary storage unit,
a mirror storage unit,
a backup storage unit,
means for disconnecting the mirror storage unit from the primary storage unit,
means for configuring the mirror storage unit as source of information to be backed up,
means for configuring the backup storage unit as a destination of information to be backed up,
means for copying information from the mirror storage unit to the backup storage unit, and
means for reconnecting the mirror storage unit to the primary storage unit.

29. The system according to claim 28, wherein said primary storage unit includes
means for queuing instructions modifying information stored in said primary storage unit while communication link with said mirror storage unit is disconnected, and
means for forwarding instructions to said mirror storage unit when said mirror storage unit is connected.

30. The system according to claim 28, wherein said copying means includes means for facilitating completion of the backup in less than one hour.

31. The system according to claim 28, wherein said copying means includes a plurality of gigabit connections between said mirror storage unit and said backup storage unit.

32. The system according to claim 28, wherein said primary storage unit includes a NVRAM.

33. The system according to claim 28, wherein each of said primary storage unit, said mirror storage unit, and said backup storage unit include a plurality of hard drives forming a storage array.

34. The system according to claim 28, wherein said primary storage unit includes
means for continuing to handle production operations with said primary storage unit when said mirror storage unit is disconnected from said primary storage unit, and
means for queuing production operations that perform modification of information present on said primary storage unit when said mirror storage unit is disconnected from said primary storage unit.

35. The system according to claim 34, wherein said primary storage unit includes means for replicating queued production operations form said primary storage unit to said mirror storage unit when said mirror storage unit reconnects to said primary storage unit.

36. A system for backing up over two terabytes of information, said system comprising a plurality of storage networks, each storage network handling at least one terabyte of information and having
a primary storage unit,
a mirror storage unit,
a backup storage unit,
means for disconnecting the mirror storage unit from the primary storage unit,
means for configuring the mirror storage unit as source of information to be backed up,
means for configuring the backup storage unit as a destination of information to be backed up,
means for copying information from the mirror storage unit to the backup storage unit,
means for reconnecting the mirror storage unit to the primary storage unit, and
said plurality of storage networks allow multiple terabytes of information to be backed up in parallel with each storage network operating independent of the other at least one storage network.

37. The system according to claim 36, wherein at least one copying means includes means for facilitating completion of the backup in less than one hour.

38. The system according to claim 36, wherein at least one copying means includes a plurality of gigabit connections between each pair of said mirror storage unit and said backup storage unit.

39. The system according to claim 36, wherein at least one primary storage unit includes a NVRAM.

40. The system according to claim 36, wherein each of said primary storage unit, said mirror storage unit, and said backup storage unit include a plurality of hard drives forming a storage array.
